(19) United States
(12) Patent Application Publication
(10) Pub. No.: US 2010/0296706 A1
(43) Pub. Date: Nov. 25, 2010

(54) IMAGE RECOGNITION APPARATUS FOR IDENTIFYING FACIAL EXPRESSION OR INDIVIDUAL, AND METHOD FOR THE SAME

(75) Inventors: Yuji Kaneda, Kawasaki-shi (JP); Masakazu Matsugu, Yokohama-shi (JP); Katsuhiko Mori, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/781,728

(22) Filed: May 17, 2010

(30) Foreign Application Priority Data
May 20, 2009 (JP) 2009-122414(PAT.)

(51) Int. Cl. G06K 9/00

(52) U.S. Cl. 382/118; 382/168

(57) ABSTRACT

A face detecting unit detects a person's face from input image data, and a parameter setting unit sets parameters for generating a gradient histogram indicating the gradient direction and gradient magnitude of a pixel value based on the detected face. Further, a generating unit sets a region (a cell) from which to generate a gradient histogram in the region of the detected face, and generates a gradient histogram for each such region to generate feature vectors. An expression identifying unit identifies an expression exhibited by the detected face based on the feature vectors. Thereby, the facial expression of a person included in an image is identified with high precision.

### BACKGROUND OF THE INVENTION

1. Field of the Invention

The present invention relates to an image recognition apparatus, an imaging apparatus, and a method therefor, and more particularly to a technique suitable for human face identification.

2. Description of the Related Art

There are methods for detecting vehicles or people using features called Histograms of Oriented Gradients (HOG), such as described in F. Han, Y. Shan, R. Cekander, S. Sawhney, and R. Kumar, “A Two-Stage Approach to People and Vehicle Detection With HOG-Based SVM”, PerMIS, 2006, and M. Bertozzi, A. Broggi, M. Del Rose, M. Felisa, A. Rakotomamonjy and F. Suard, “A Pedestrian Detector Using Histograms of Oriented Gradients and a Support Vector Machine Classifier”, IEEE Intelligent Transportation Systems Conference, 2007. These methods basically generate HOG features from luminance values within a rectangular window placed at a certain position on an input image. Then, the HOG features generated are input to a classifier for determining the presence of a target object to determine whether the target object is present in the rectangular window or not.

Such determination of whether a target object is present in an image is carried out by repeating the above-described process while scanning the window on the input image. A classifier for determining the presence of an object is described in V. Vapnik, “Statistical Learning Theory”, John Wiley & Sons, 1998.

The aforementioned methods for detecting vehicles or human bodies represent the contour of a vehicle or a human body as a histogram in gradient direction. Such recognition techniques based on gradient-direction histogram are mostly employed for detection of automobiles or human bodies and have not been applied to facial expression recognition and individual identification. For facial expression recognition and individual identification, the shape of an eye or a mouth that makes up a face or wrinkles that are formed when cheek muscles are raised are very important. Thus, recognition of a person's facial expression or an individual could be realized by representing the shape of an eye or a mouth or formation of wrinkles indirectly as a gradient-direction histogram and also with robustness for various variable factors.

Generation of a gradient-direction histogram involves various parameters and image recognition performance largely depends on how these parameters are set. Therefore, more precise expression recognition could be realized by setting appropriate parameters for a gradient-direction histogram based on the size of a detected face.

Conventional detection of a particular object and/or pattern, however, does not have a well-defined way to set appropriate gradient histogram parameters according to properties of the target object and category. Gradient histogram parameters as called herein are a region for generating a gradient histogram, the width of bins in a gradient histogram, the number of pixels used for generating a gradient histogram, and a region for normalizing gradient histograms.

Also, unlike detection of a vehicle or a human body, fine features such as wrinkles are very important for expression recognition and individual identification as mentioned above in addition to the shape of primary features such as eyes and a mouth. However, because wrinkles are small features when compared to eyes or a mouth, parameters for representing the shape of an eye or a mouth as gradient histograms are largely different from parameters for representing wrinkles or the like as gradient histograms. In addition, fine features such as wrinkles have lower reliability as face size becomes smaller.

### SUMMARY OF THE INVENTION

An object of the present invention is to identify a facial expression or an individual contained in an image with high precision.

According to one aspect of the present invention, an image recognition apparatus is provided which comprises: a detecting unit that detects a person's face from input image data; a parameter setting unit that sets parameters for generating a gradient histogram indicating gradient direction and gradient magnitude of a pixel value, based on the detected face; a region setting unit that sets, in the region of the detected face, at least one region from which the gradient histogram is to be generated, based on the set parameters; a generating unit that generates the gradient histogram for each of the set regions, based on the set parameters; and an identifying unit that identifies the detected face using the generated gradient histogram.

Further features of the present invention will become apparent from the following description of exemplary embodiments with reference to the attached drawings.

### BRIEF DESCRIPTION OF THE DRAWINGS

FIGS. 1A, 1B, 1C and 1D are block diagrams illustrating exemplary functional configurations of an image recognition apparatus.

FIGS. 2A and 2B illustrate examples of face detection.

FIGS. 3A, 3B, 3C, 3D and 3E illustrate examples of tables used.

FIG. 4 illustrates an example of definition of eye, cheek, and mouth regions.

FIG. 5 is a block diagram illustrating an example of detailed configuration of a gradient-histogram feature vector generating unit.

FIGS. 6A, 6B and 6C illustrate parameter tables.

FIGS. 7A and 7B illustrate examples of correspondence between expression codes and motions, and expressions and expression codes.

FIGS. 8A and 8B illustrate gradient magnitude and gradient direction as represented as images.

FIG. 9 illustrates tank⁻¹ and an approximation straight line.

FIG. 10 illustrates regions (cells) for generating gradient histograms.

FIG. 11 illustrates a classifier for identifying each expression code.

FIG. 12 illustrates an example of overlapping cells.

FIGS. 13A and 13B generally and conceptually illustrate gradient histograms generated in individual cells from gradient magnitude and gradient direction.

FIG. 14 is a flowchart illustrating an example of processing procedure from input of image data to face recognition.

FIG. 15 illustrates an example of cells selected when histograms are generated.

FIGS. 16A and 16B conceptually illustrate identification of a group or an individual from generated feature vectors.

FIG. 17 conceptually illustrates 3×3 cells as a normalization region.

FIG. 18 illustrates an exemplary configuration of an imaging apparatus.

FIG. 19 illustrates an example of defining regions from which to generate gradient histograms as local regions.

FIG. 20 illustrates an example of processing procedure for identifying multiple expressions.

FIG. 21 is a flowchart illustrating an example of processing procedure from input of image data to face recognition.

FIG. 22 is a flowchart illustrating an example of processing procedure for retrieving parameters.

FIG. 23 is comprised of FIGS. 23A and 23B showing flowcharts illustrating an example of an entire processing procedure for the imaging apparatus.

FIG. 24 illustrates an example of a normalized image.

### DESCRIPTION OF THE EMBODIMENTS

Preferred embodiments of the present invention will now be described in detail in accordance with the accompanying drawings.

### First Embodiment

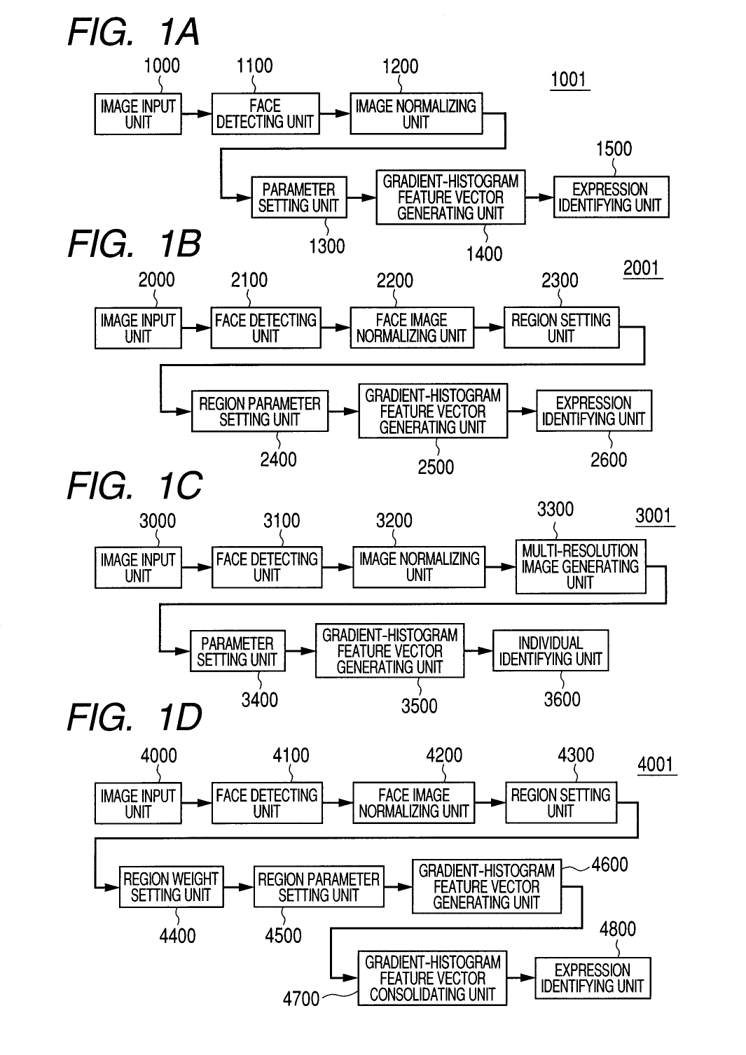

The first embodiment describes an example of setting gradient histogram parameters based on face size. FIG. 1A illustrates an exemplary functional configuration of an image recognition apparatus 1001 according to the first embodiment. In FIG. 1A, the image recognition apparatus 1001 includes an image input unit 1000, a face detecting unit 1100, an image normalizing unit 1200, a parameter setting unit 1300, a gradient-histogram feature vector generating unit 1400, and an expression identifying unit 1500. The present embodiment discusses processing for recognizing a facial expression.

The image input unit 1000 inputs image data that results from passing through a light-collecting element such as a lens, an imaging element for converting light to an electric signal, such as CMOS and CCD, and an AD converter for converting an analog signal to a digital signal. Image data input to the image input unit 1000 also has been converted to image data of a low resolution through thinning or the like. For example, image data converted to VGA (640×480 (pixels)) or QVGA (320×240 (pixels)) is input.

The face detecting unit 1100 executes face recognition on image data input to the image input unit 1000. Available methods for face detection include ones described in Yusuke Mitarai, Katsuhiko Mori, and Masakazu Matsugu, “Robust face detection system based on Convolutional Neural Networks using selective activation of modules”, FIT (Forum on Information Technology), L1-013, 2003, and P. Viola, M. Jones, “Rapid Object Detection using a Boosted Cascade of Simple Features”, in Proc. Of COPRA, viol's, pp. 511-518, December, 2001, for example. The present embodiment adopts the former method.

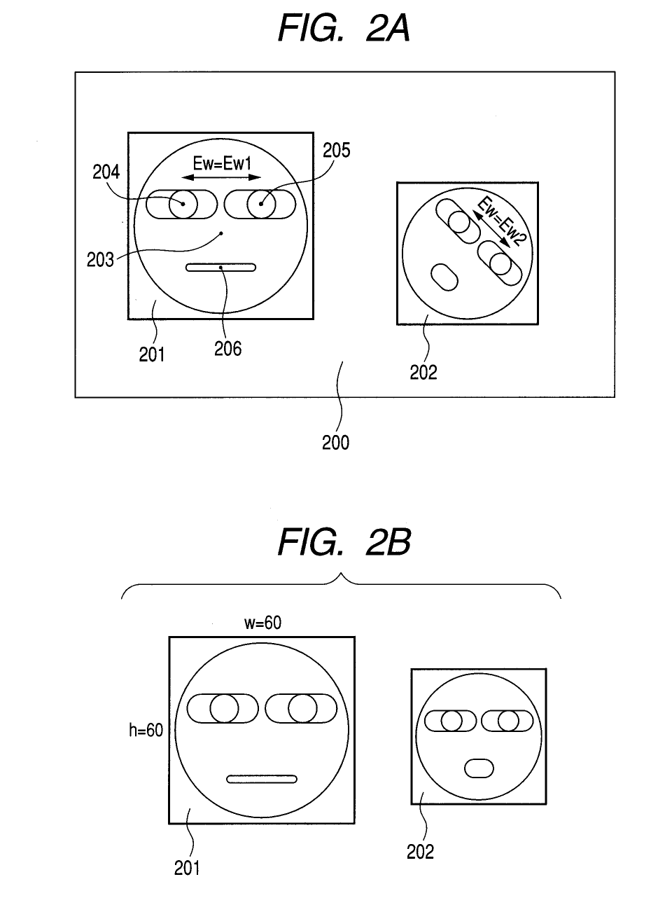

The present embodiment using the method extracts high-level features (eye, mouth and face level) from low-level features (edge level) hierarchically using Convolutional Neural Networks. The face detecting unit 1100 therefore can derive not only face center coordinates 203 shown in FIG. 2A but right-eye center coordinates 204, left-eye center coordinates 205, and mouth center coordinates 206. Information on the face center coordinates 203, the right-eye center coordinates 204 and the left-eye center coordinates 205 derived by the face detecting unit 1100 is used in the image normalizing unit 1200 and the parameter setting unit 1300 as described later.

The image normalizing unit 1200 uses the information on the face center coordinates 203, the right-eye center coordinates 204, and the left-eye center coordinates 205 derived by the face detecting unit 1100 to generate an image that contains only a face region (hereinafter, a face image). At the time of generation, the face region is normalized by clipping the face region out of the image data input to the image input unit 1000 and applying affine transformation to the face region so that the image has predetermined width w and height h and the face has upright orientation.

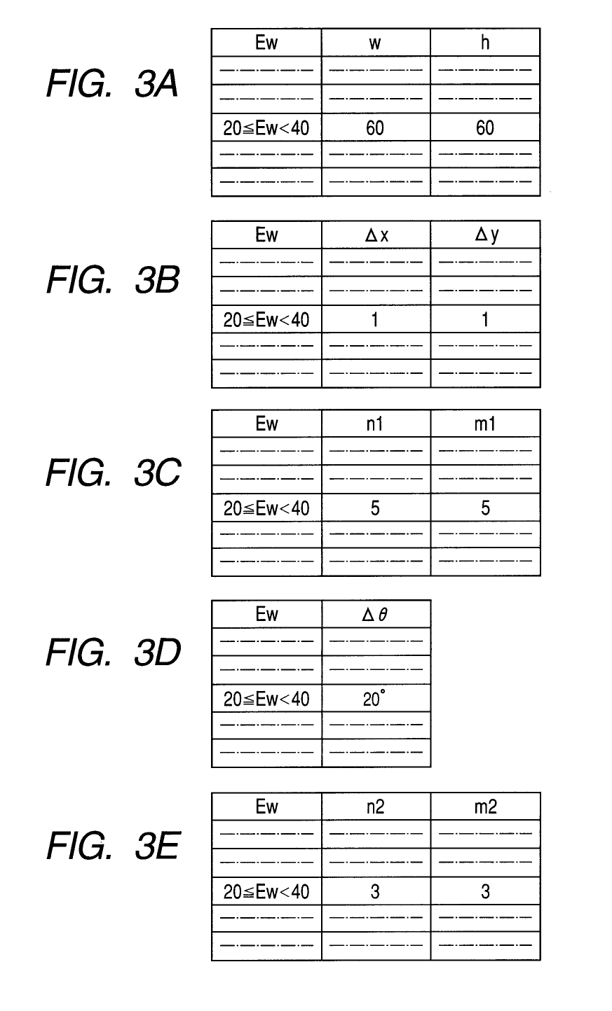

If another face 202 is also detected by the face detecting unit 1100 as illustrated in FIG. 2A, the image normalizing unit 1200 uses a distance between eye centers Ew calculated from the result of face detection and a table for determining the size of an image to be generated, such as shown in FIG. 3A, to generate a face image that has predetermined width w and height h and that makes the face upright.

For example, when the distance between eye centers Ew1 of face 201 shown in FIG. 2A is 30, the width w and height h of the image to be generated are set to 60 and 60, respectively, as shown in FIG. 2B according to the table of FIG. 3A. For the orientation of the face, an inclination calculated from the right-eye center coordinates 204 and the left-eye center coordinates 205 is used. The settings of the table shown in FIG. 3A is an example and is not limitative. The following description assumes that the distance between eye centers Ew1 is 30 and the width and height of the image generated are both 60 in the face 201 shown in FIG. 2A.

The parameter setting unit 1300 sets parameters for use in the gradient-histogram feature vector generating unit 1400 based on the distance between eye centers Ew. That is to say, in the present embodiment, parameters for use in generation of a gradient histogram described below are set according to the size of a face detected by the face detecting unit 1100. Although the present embodiment uses the distance between eye centers Ew to set parameters for use by the gradient-histogram feature vector generating unit 1400, any value representing face size may be used instead of the distance between eye centers Ew.

Parameters set by the parameter setting unit 1300 are the following four parameters, which will be each described in more detail later:
First parameter: a distance to neighboring four pixel values used for calculating gradient direction and magnitude (Δx and Δy)
Second parameter: a region in which one gradient histogram is generated (hereinafter, a cell)
Third parameter: the width of bins in a gradient histogram
Fourth parameter: a region in which a gradient histogram is normalized

The gradient-histogram feature vector generating unit 1400 includes a gradient magnitude/direction calculating unit 1410, a gradient histogram generating unit 1420, and a normalization processing unit 1430 as shown in FIG. 5, and generates feature vectors for recognizing expressions.

The gradient magnitude/direction calculating unit 1410 calculates a gradient magnitude and a gradient direction within a predetermined area on all pixels in a face image clipped out by the image normalizing unit 1200. Specifically, the gradient magnitude/direction calculating unit 1410 calculates gradient magnitude m(x, y) and gradient direction θ(x, y) at certain coordinates (x, y) by Equation (1) below using luminance values of neighboring four pixels on the top, bottom, left and right of the pixel of interest at the coordinates (x, y)(i.e., I(x−Δx, y), I(x+Δx, y), I (x, y−Δy), I (x, y+Δy)).

$$m ( x , y ) = \sqrt{{( \begin{matrix}I ( x + Δ x , y ) - \\ I ( x - Δ x , y )\end{matrix} )}^{2} + {( \begin{matrix}I ( x , y + Δ y ) - \\ I ( x , y - Δ y )\end{matrix} )}^{2}} \\ θ ( x , y ) = {tan}^{- 1} ( ( \begin{matrix}I ( x , y + Δ y ) - \\ I ( x , y - Δ y )\end{matrix} ) / ( \begin{matrix}I ( x + Δ x , y ) - \\ I ( x - Δ x , y )\end{matrix} ) ) \qquad ( 1 )$$

The first parameters Δx and Δy are parameters for calculating gradient magnitude and gradient direction, and these values are set by the parameter setting unit 1300 using a prepared table or the like based on the distance between eye centers Ew.

FIG. 3B illustrates an example of a table on Δx and Δy values that are set based on the distance between eye centers Ew. For example, for a distance between eye centers Ew of 30 (pixels) (a 60×60 pixel image), the parameter setting unit 1300 sets Δx=1 and Δy=1. The gradient magnitude/direction calculating unit 1410 substitutes 1 into both Δx and Δy to calculate gradient magnitude and gradient direction for each pixel of interest.

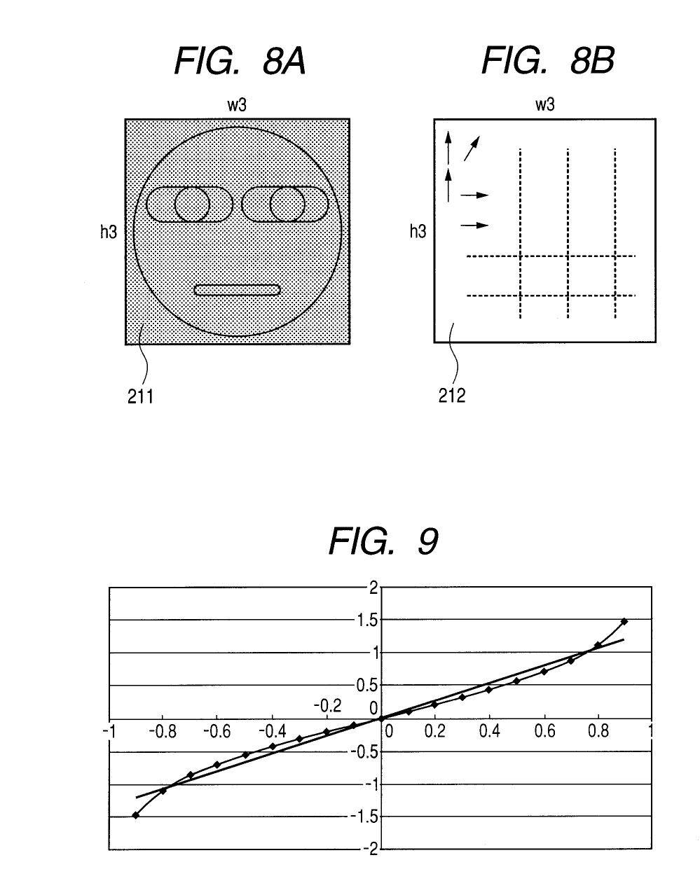

FIGS. 8A and 8B illustrate an example of gradient magnitude and gradient direction calculated for the face 201 of FIG. 2B and each represented as an image (hereinafter, a gradient magnitude/direction image). White portions of image 211 shown in FIG. 8A indicate a large gradient, and the arrows on image 212 shown in FIG. 8B indicate directions of gradient. In calculation of gradient direction, approximation of tank⁻¹ as a straight line can reduce processing burden and realize faster processing, as illustrated in FIG. 9.

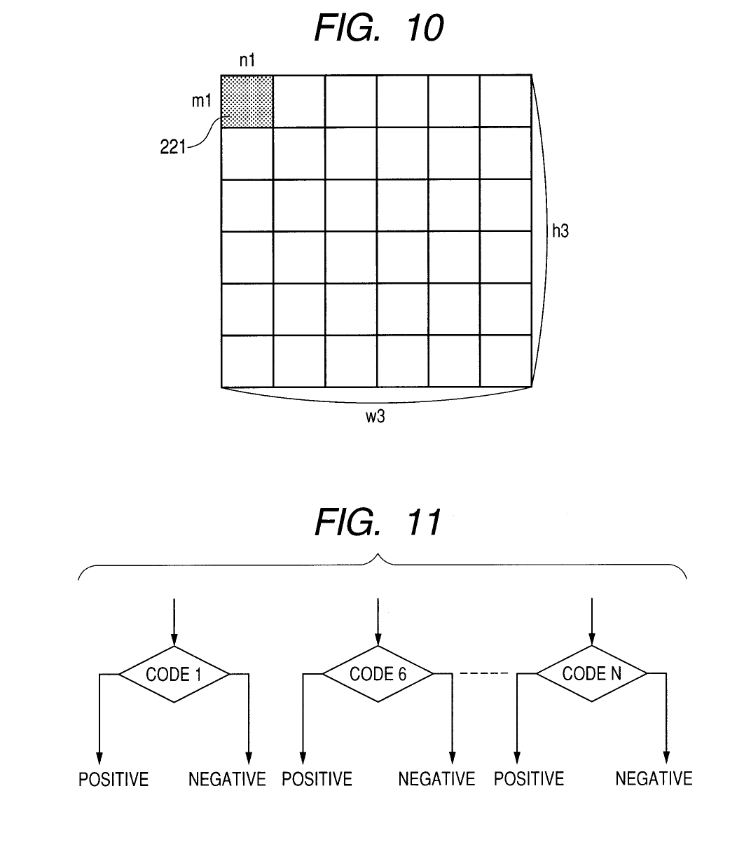

The gradient histogram generating unit 1420 generates a gradient histogram using the gradient magnitude and direction image generated by the gradient magnitude/direction calculating unit 1410. The gradient histogram generating unit 1420 first divides the gradient magnitude/direction image generated by the gradient magnitude/direction calculating unit 1410 into regions 211 each having a size of n1×m1 (pixels) (hereinafter, a cell), as illustrated in FIG. 10.

Setting of a cell, which is the second parameter, to n1×m1 (pixels) is also performed by the parameter setting unit 1300 using a prepared table or the like.

FIG. 3C illustrates an example of a table on width n1 and height m1 of the regions 221 which are set based on the distance between eye centers Ew. For example, for a distance between eye centers Ew of 30 (pixels) (a 60×60 (pixel) image), a cell (n1×m1) is set to 5×5 (pixels). While the present embodiment sets regions so that cells do not overlap as shown in FIG. 10, areas may be defined such that cells overlap between a first area 225 and a second area 226 as illustrated in FIG. 12. This way of region setting improves robustness against variation.

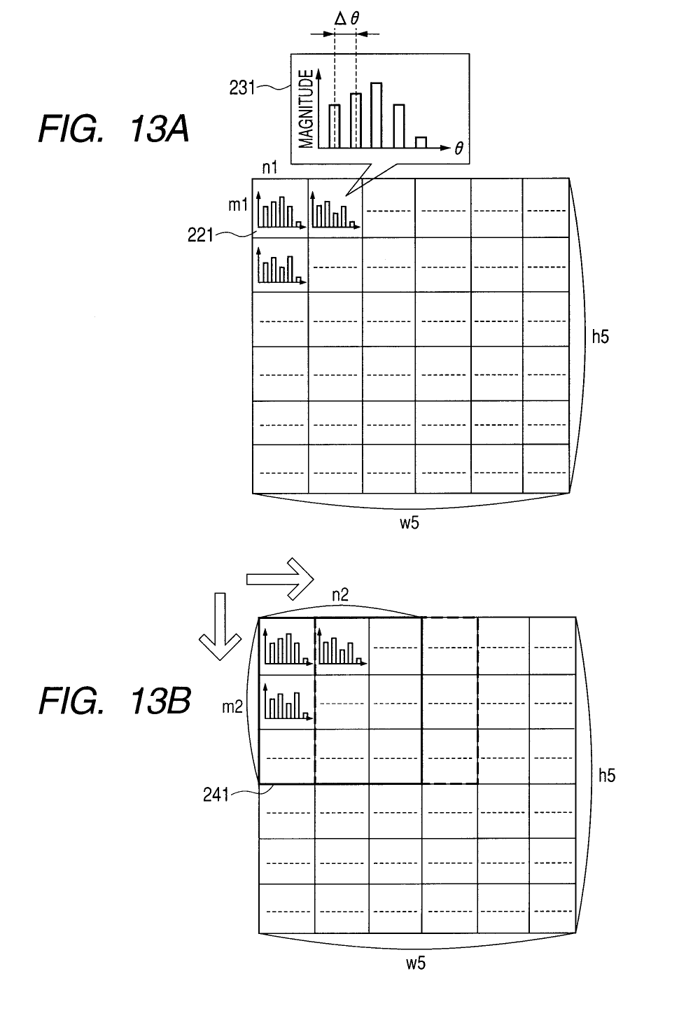

The gradient histogram generating unit 1420 next generates a histogram with the horizontal axis thereof representing gradient direction and vertical axis representing the sum of magnitudes for each n1×m1 (pixel) cell, as illustrated in FIG. 13A. In other words, one gradient histogram 231 is generated using the values of n1×m1 gradient magnitudes and a value of gradient direction.

The horizontal axis of the gradient histogram 231 (bin width), which is the third parameter, is one of parameters set by the parameter setting unit 1300 using a prepared table or the like. To be specific, the parameter setting unit 1300 sets the bin width Δθ of the gradient histogram 231 shown in FIG. 13A based on the distance between eye centers Ew.

FIG. 3D illustrates an example of a table for determining the bin width of the gradient histogram 231 based on the distance between eye centers Ew. For example, for a distance between eye centers Ew of 30 (pixels) (a 60×60 (pixel) image), the bin width Δθ of the gradient histogram 231 is set to 20°. Since the present embodiment assumes the maximum value of θ is 180°, the number of bins in the gradient histogram 231 is nine in the example shown in FIG. 3D.

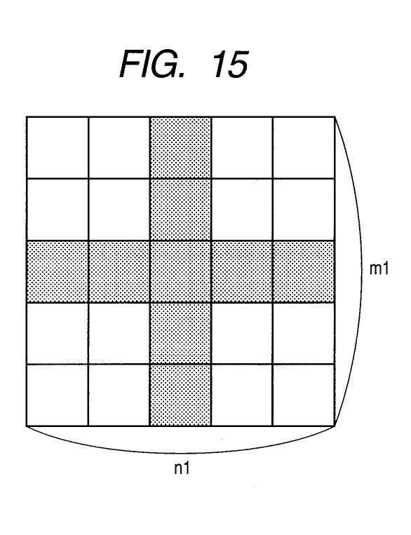

Thus, the present embodiment generates a gradient histogram using values of all of n1×m1 gradient magnitudes of FIG. 10 and a gradient direction value. However, as illustrated in FIG. 15, only some of n1×m1 gradient magnitude values and a gradient direction value may be used to generate a gradient histogram.

The normalization processing unit 1430 of FIG. 5 normalizes each element of a gradient histogram in an n2×m2 (cells) window 241 while moving the n2×m2 (cells) window 241 by one cell as illustrated in FIG. 13B. When a cell in ith row and jth column is denoted as Fᵢⱼ and the number of bins in a histogram that constitutes the cell Fᵢⱼ is denoted as n, the cell Fᵢⱼ can be represented as: [fᵢⱼ_{_{—}}₁, . . . , fᵢⱼ_{_{—}}ₙ]. For the sake of clarity, the following descriptions on normalization assume that n2×m2 is 3×3 (cells) and the number of bins in a histogram is n=9.

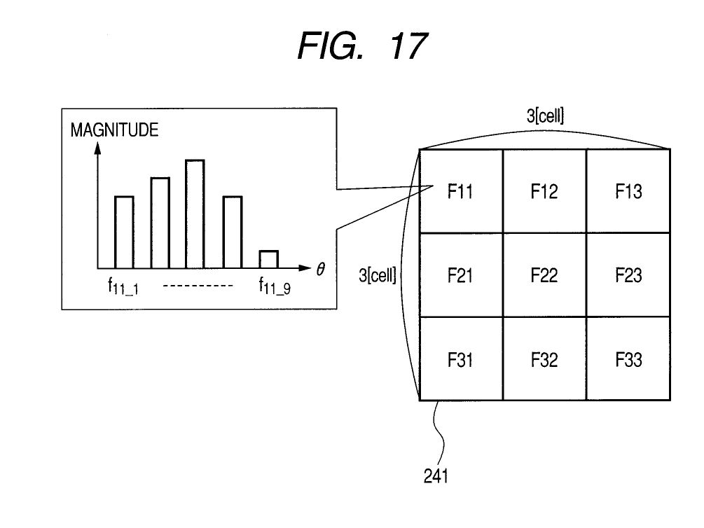

The 3×3 cells can be represented as F11 to F33, as shown in FIG. 17. Also, cell F₁₁, for example, can be represented as F₁₁=[f₁₁_{_{—}}₁, . . . , f₁₁_{_{—}}₉] as illustrated in FIG. 17. In a normalization process, Norm is first calculated using Equation (2) below for the 3×3 (cells) shown in FIG. 17. The present embodiment adopts L2 Norm.

$${Norm}_{1} = \sqrt{\begin{matrix}{( {F}_{11} )}^{2} + {( {F}_{12} )}^{2} + {( {F}_{13} )}^{2} + \\ {( {F}_{21} )}^{2} + {( {F}_{22} )}^{2} + {( {F}_{23} )}^{2} + \\ {( {F}_{31} )}^{2} + {( {F}_{32} )}^{2} + {( {F}_{313} )}^{2}\end{matrix}} \qquad ( 2 )$$

For example, (F₁₁)² can be represented as Equation (3):

(F₁₁)²=(f₁₁_{_{—}}₁)²+(f₁₁_{_{—}}₂)²+ . . . +(f₁₁_{_{—}}₈)²+(f₁₁_{_{—}}₉)² (3)

Next, using Equation (4), each cell Fᵢⱼ is divided by the Norm calculated using Equation (2) to carry out normalization.

V₁=[F₁₁/Norm₁, F₁₂/Norm₁, . . . , F₃₂/ Norm₁, F₃₃/Norm₁] (4)

Then, calculation with Equation (4) is repeated on all of w5×h5 cells shifting the 3×3 (cell) window by one cell, and normalized histograms that have been generated are represented as a feature vector V. Therefore, a feature vector V can be represented by Equation (5):

V=[V₁, V₂, . . . , Vₖ₋₁, Vₖ] (5)

The size (region) of window 241 used at the time of normalization, which is the fourth parameter, is also a parameter set by the parameter setting unit 1300 using a prepared table or the like. FIG. 3E illustrates an example of a table for determining the width n2 and height m2 of window 241 for use at the time of normalization based on the distance between eye centers Ew. For example, for a distance between eye centers Ew of 30 (pixels) (a 60×60 pixel image), the normalization region is set to n2×m2=3×3 (cells) as shown in FIG. 3E.

The normalization is performed for reducing effects such as variation in lighting. Therefore, the normalization does not have to be performed in an environment with relatively good lighting conditions. Also, depending on the direction of a light source, only a part of a normalized image can be shade, for example. In such a case, a mean value and a variance of luminance values may be calculated for each n1×m1 region illustrated in FIG. 10, and normalization may be performed only if the mean value is smaller than a predetermined threshold and the variance is smaller than a predetermined threshold, for example.

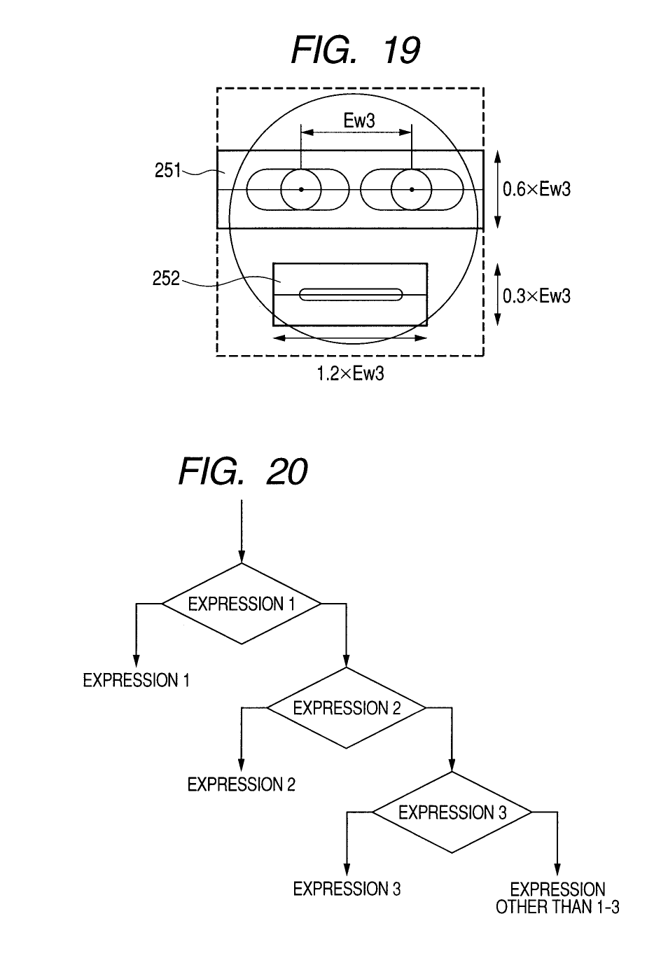

Although the present embodiment generates the feature vector V from the entire face, feature vector V may be generated only from local regions including an around-eyes region 251 and an around-mouth region 252, which are especially sensitive to change in expression, as illustrated in FIG. 19. In this case, because positions of left and right eye centers, the center of mouth, and the face have been identified, local regions are defined using these positions and the distance between eye centers Ew3.

The expression identifying unit 1500 of FIG. 1A uses the SVMs mentioned above to identify a facial expression. Since an SVM is based on binary decision, a number of SVMs are prepared for determining each individual facial expression and determinations with the SVMs are sequentially executed to finally identify a facial expression as illustrated in the procedure of FIG. 20.

The expression identification illustrated in FIG. 20 varies with the size of an image generated by the image normalizing unit 1200, and expression identification corresponding to the size of an image generated by the image normalizing unit 1200 is performed. The expression (1) shown in FIG. 20 is learned by an SVM using data on the expression (1) and data on other expressions, e.g., an expression of joy and other expressions.

For identification of a facial expression, two methodologies are possible. The first is to directly identify an expression from feature vector V as in the present embodiment. The second is to estimate movements of facial expression muscles that make up a face from feature vector V and identify a predefined expression rule that matches the combination of estimated movements of facial expression muscles to thereby identify an expression. For expression rules, a method described in P. Ekman and W. Frisen, “Facial Action Coding System”, Consulting Psychologists Press, Palo Alto, Calif., 1978, is employed.

When expression rules are used, SVMs of the expression identifying unit 1500 serve as classifiers for identifying corresponding movements of facial expression muscles. Accordingly, when there are 100 ways of movement of facial expression muscles, SVMs for recognizing 100 expression muscles are prepared.

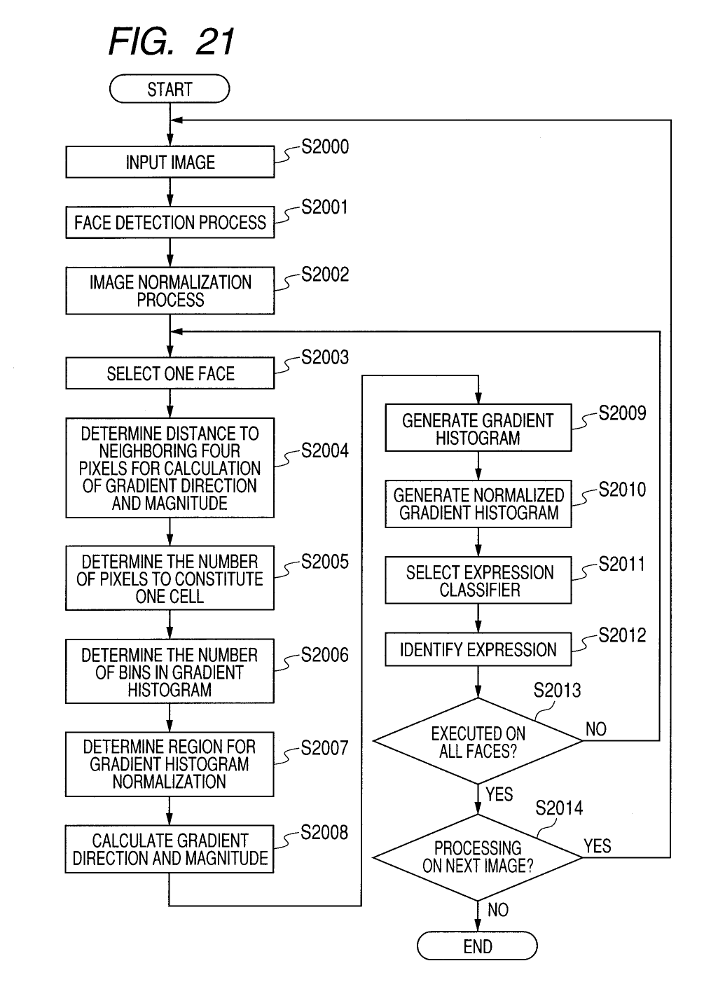

FIG. 21 is a flowchart illustrating an example of processing procedure from input of image data to face recognition in the image recognition apparatus 1001 of FIG. 1A.

First, at step S2000, the image input unit 1000 inputs image data. At step S2001, the face detecting unit 1100 executes face detection on the image data input at step S2000.

At step S2002, the image normalizing unit 1200 performs clipping of a face region and affine transformation based on the result of face detection performed at step S2001 to generate a normalized image. For example, when the input image contains two faces, two normalized images can be derived. Then, at step S2003, the image normalizing unit 1200 selects one of the normalized images generated at step S2002.

Then, at step S2004, the parameter setting unit 1300 determines a distance to neighboring four pixels for calculating gradient direction and gradient magnitude based on the distance between eye centers Ew in the normalized image selected at step S2003, and sets the distance as the first parameter. At step S2005, the parameter setting unit 1300 determines the number of pixels to constitute one cell based on the distance between eye centers Ew in the normalized image selected at step S2003, and sets the number as the second parameter.

Then, at step S2006, the parameter setting unit 1300 determines the number of bins in a gradient histogram based on the distance between eye centers Ew in the normalized image selected at step S2003 and sets the number as the third parameter. At step S2007, the parameter setting unit 1300 determines a normalization region based on the distance between eye centers Ew in the normalized image selected at step S2003 and sets the region as the fourth parameter.

Then, at step S2008, the gradient magnitude/direction calculating unit 1410 calculates gradient magnitude and gradient direction based on the first parameter set at step S2004. At step S2009, the gradient histogram generating unit 1420 generates a gradient histogram based on the second and third parameters set at steps S2005 and S2006.

Then, at step S2010, the normalization processing unit 1430 carries out normalization on the gradient histogram according to the fourth parameter set at step S2007. At step S2011, the expression identifying unit 1500 selects an expression classifier (SVM) appropriate for the size of the normalized image based on the distance between eye centers Ew in the normalized image. At step S2012, expression identification is performed using the SVM selected at step S2011 and feature vector V generated from elements of the normalized gradient histogram generated at step S2010.

At step S2013, the image normalizing unit 1200 determines whether expression identification has been executed on all faces detected at step S2001. If expression identification has not been executed on all faces, the flow returns to step S2003. However, if it is determined at step S2013 that expression identification has been executed on all of the faces, the flow proceeds to step S2014.

Then, at step S2014, it is determined whether expression identification should be performed on the next image. If it is determined that expression identification should be performed on the next image, the flow returns to step S2000. If it is determined at step S2014 that expression identification is not performed on the next image, the entire process is terminated.

Next, how to prepare the tables shown in FIGS. 3A to 3E will be described.

To create the tables shown in FIGS. 3A to 3E, a list of various parameter values, learning images for learning including expressions, and test images for verifying the result of learning are prepared first. Next, an expression classifier (SVM) is made to learn using feature vector V generated with certain parameters and a learning image, and the expression classifier after learning is evaluated with a test image. By performing this process on all combinations of parameters, optimal parameters are determined.

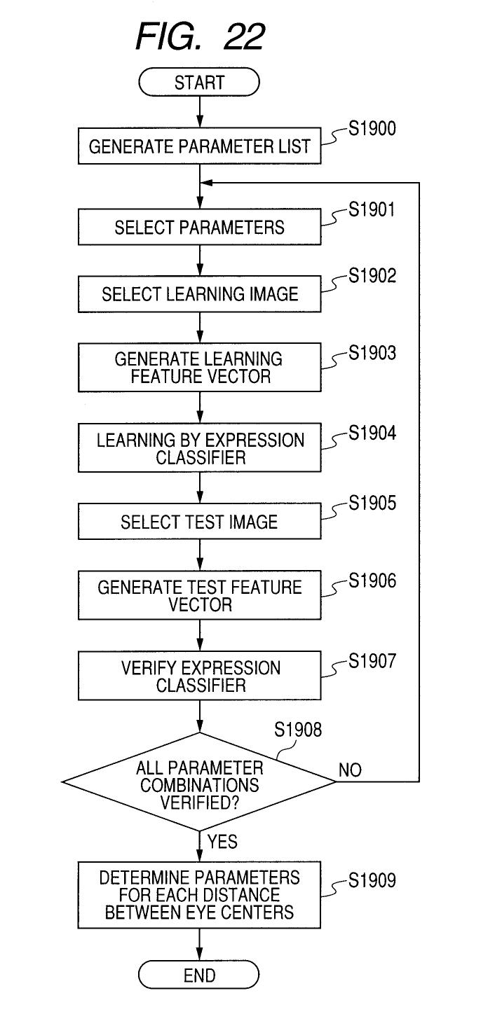

FIG. 22 is a flowchart illustrating an example of processing procedure for examining parameters.

First, at step S1900, the parameter setting unit 1300 generates a parameter list. Specifically, a list of the following parameters is created.
(1) Width w and height h of an image for normalization shown in FIG. 3A
(2) the distance to neighboring four pixel values for calculating gradient direction and gradient magnitude shown in FIG. 3B (Δx and Δy, the first parameter)
(3) the number of pixels to constitute one cell shown in FIG. 3C (the second parameter)
(4) the number of bins in a gradient histogram shown in FIG. 3D (the third parameter)
(5) a region for normalizing a gradient histogram shown in FIG. 3E (the fourth parameter)

At step S1901, the parameter setting unit 1300 selects a combination of parameters from the parameter list. For example, the parameter setting unit 1300 selects a combination of parameters like 20≦Ew<30, w=50, h=50, Δx=1, Δy=1, n1=5, m1=1, Δθ=15, n2=3, m2=3.

Then, at step S1902, the image normalizing unit 1200 selects an image that corresponds to the distance between eye centers Ew selected at step S1901 from prepared learning images. In the learning images, a distance between eye centers Ew and an expression label as correct answers are included in advance.

At step S1903, the normalization processing unit 1430 generates feature vectors V using the learning image selected at step S1902 and the parameters selected at step S1901. At step S1904, the expression identifying unit 1500 has the expression classifier learn using all feature vectors V generated at step S1903 and the correct-answer expression label.

At step S1905, from among test images prepared separately from the learning images, an image that corresponds to the distance between eye centers Ew selected at step S1901 is selected. At step S1906, feature vectors V are generated from the test image as in step S1903.

Next, at step S1907, the expression identifying unit 1500 verifies the accuracy of expression identification using the feature vectors V generated at step S1906 and the expression classifier that learned at step S1904.

Then, at step S1908, the parameter setting unit 1300 determines whether all combinations of parameters generated at step S1900 have been verified. If it is determined that not all parameter combinations have been verified, the flow returns to step S1901, and the next parameter combination is selected. If it is determined at step S1908 that all parameter combinations have been verified, the flow proceeds to step S1909, where parameters that provide the highest expression identification rate are set in tables according to the distance between eye centers Ew.

As described above, the present embodiment determines parameters for generating gradient histograms based on a detected distance between eye centers Ew to identify a facial expression. Thus, more precise expression identification can be realized.

### Second Embodiment

The second embodiment of the invention will be described below. The second embodiment shows a case where parameters are varied from one facial region to another.

FIG. 1B is a block diagram illustrating an exemplary functional configuration of an image recognition apparatus 2001 according to the second embodiment.

In FIG. 1B, the image recognition apparatus 2001 includes an image input unit 2000, a face detecting unit 2100, a face image normalizing unit 2200, a region setting unit 2300, a region parameter setting unit 2400, a gradient-histogram feature vector generating unit 2500, and an expression identifying unit 2600. As the image input unit 2000 and the face detecting unit 2100 are similar to the image input unit 1000 and the face detecting unit 1100 of FIG. 1A described in the first embodiment, their descriptions are omitted.

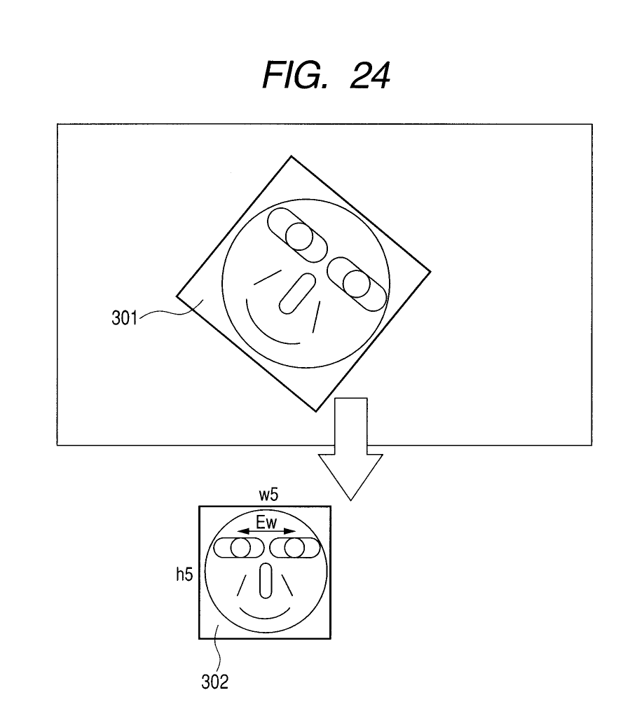

The face image normalizing unit 2200 performs image clipping and affine transformation on a face 301 detected by the face detecting unit 2100 so that the face is correctly oriented and the distance between eye centers Ew is a predetermined distance, as illustrated in FIG. 24. Then, the face image normalizing unit 2200 generates a normalized face image 302. In the present embodiment, normalization is performed so that the distance between eye centers Ew is 30 in all face images.

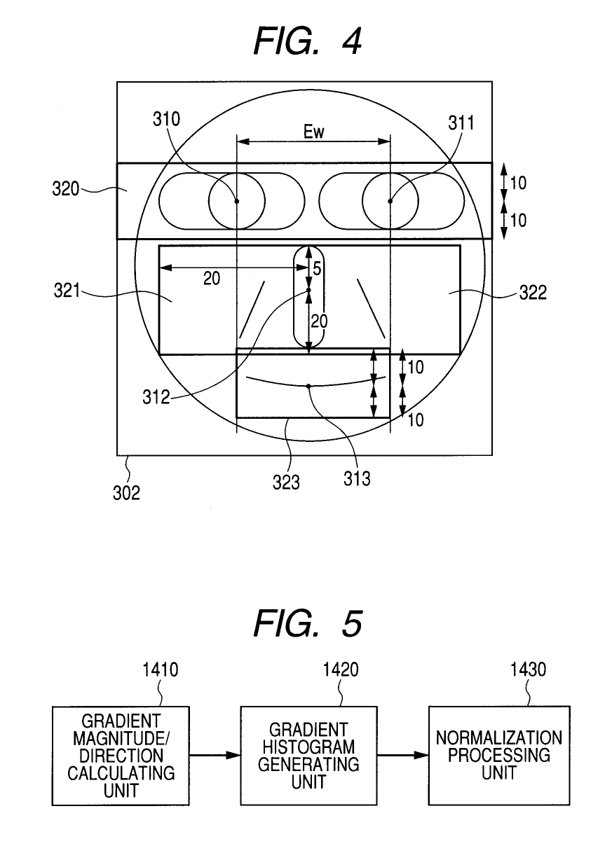

The region setting unit 2300 sets regions on the image normalized by the face image normalizing unit 2200. Specifically, the region setting unit 2300 sets regions as illustrated in FIG. 4 using right-eye center coordinates 310, left-eye center coordinates 311, face center coordinates 312, and mouse center coordinates 313.

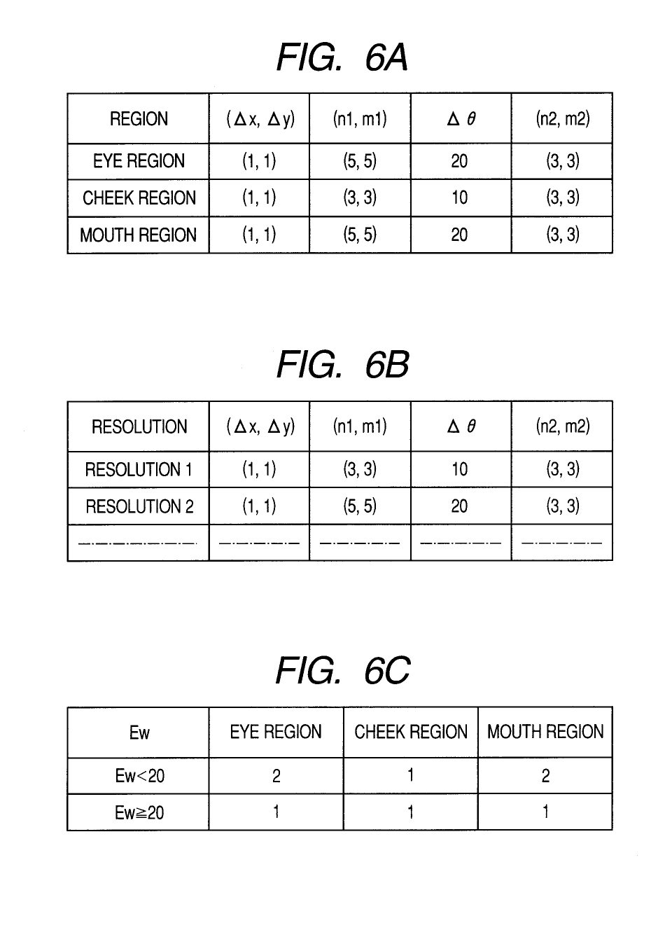

The region parameter setting unit 2400 sets parameters for generating gradient histograms at the gradient-histogram feature vector generating unit 2500 for each of regions set by the region setting unit 2300. In the present embodiment, parameter values for individual regions are set as illustrated in FIG. 6A, for example. For a right-cheek region 321 and a left-cheek region 322 of FIG. 4, to capture a change in fine features such as formation of wrinkles with lift of muscles, a region for generating a gradient histogram (n1, m1) as well as the bin width Δθ of a gradient histogram are made small.

The gradient-histogram feature vector generating unit 2500 generates feature vectors in the regions as the gradient-histogram feature vector generating unit 1400 described in the first embodiment, using the parameters set by the region parameter setting unit 2400. In the present embodiment, a feature vector generated from an eye region 320 is denoted as Ve, a feature vector generated from the right-cheek and left-cheek regions 321 and 322 as Vc, and a feature vector generated from the mouth region 323 as Vm.

The expression identifying unit 2600 performs expression identification using the feature vectors Ve, Vc and Vm generated by the gradient-histogram feature vector generating unit 2500. The expression identifying unit 2600 performs expression identification by identifying expression codes described in “Facial Action Coding System” mentioned above.

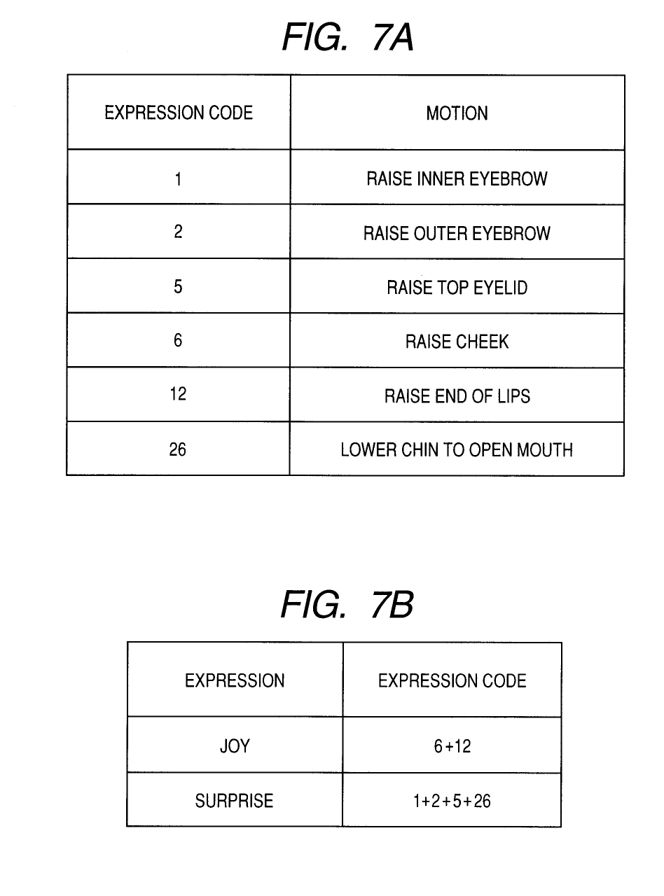

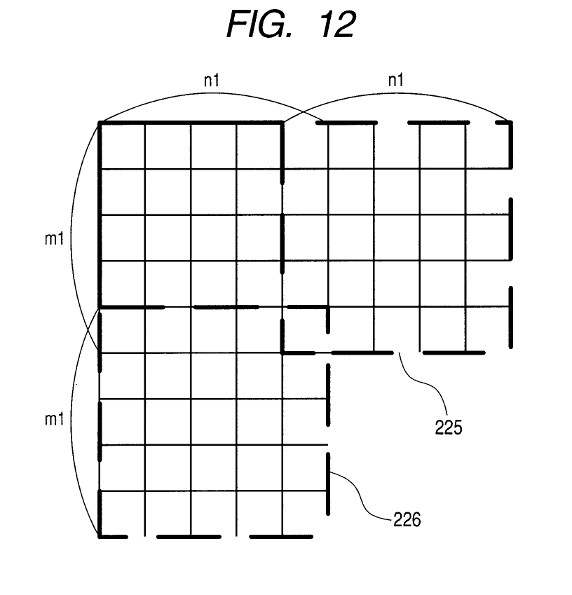

An example of correspondence between expression codes and motions is shown in FIG. 7A. For example, as shown in FIG. 7B, expression of joy can be represented by expression codes 6 and 12, and expression of surprise can be represented by expression codes 1, 2, 5 and 26. To be specific, classifiers each corresponding to an expression code are prepared as shown in FIG. 11. Then, the feature vectors Ve, Vc and Vm generated by the gradient-histogram feature vector generating unit 2500 are input to the classifiers, and an expression is identified by detecting which expression codes are occurring. For identification of expression codes, SVMs are used as in the first embodiment.

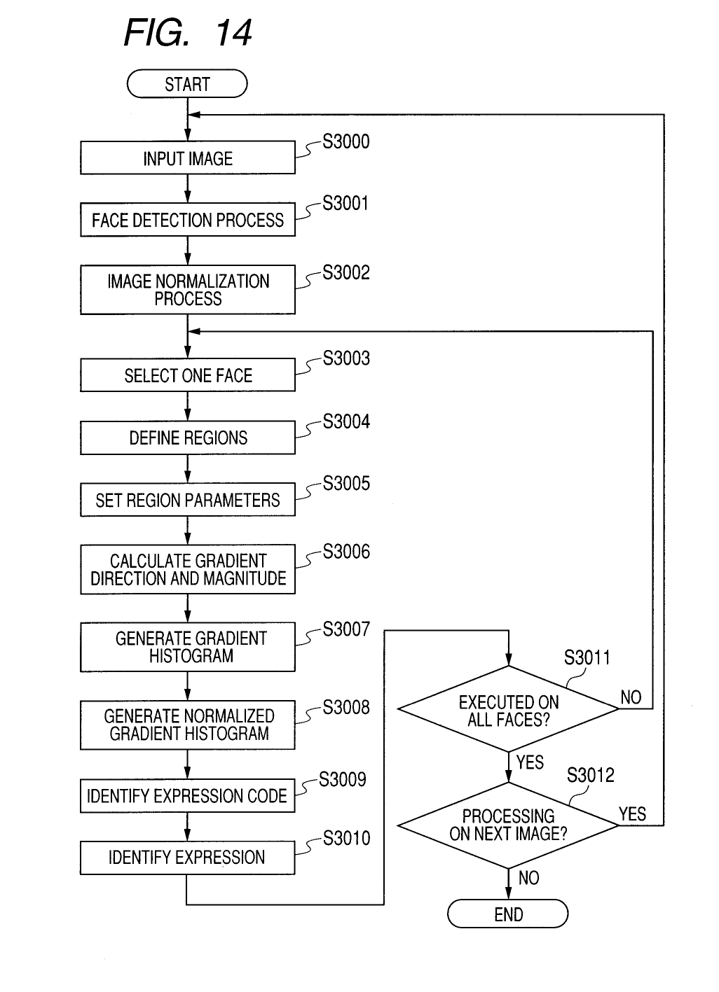

FIG. 14 is a flowchart illustrating an example of processing procedure from input of image data to face recognition in the present embodiment.

First, at step S3000, the image input unit 2000 inputs image data. At step S3001, the face detecting unit 2100 executes face detection on the input image data.

At step S3002, the face image normalizing unit 2200 performs face-region clipping and affine transformation based on the result of face detection to generate normalized images. For example, when the input image contains two faces, two normalized images can be obtained. At step S3003, the face image normalizing unit 2200 selects one of the normalized images generated at step S3002.

Then, at step S3004, the region setting unit 2300 sets regions, such as eye, cheek, and mouth regions, in the normalized image selected at step S3003. At step S3005, the region parameter setting unit 2400 sets parameters for generating gradient histograms for each of the regions set at step S3004.

At step S3006, the gradient-histogram feature vector generating unit 2500 calculates gradient direction and gradient magnitude using the parameters set at step S3005 in each of the regions set at step S3004. Then, at step S3007, the gradient-histogram feature vector generating unit 2500 generates a gradient histogram for each region using the gradient direction and gradient magnitude calculated at step S3006 and the parameters set at step S3005.

At step S3008, the gradient-histogram feature vector generating unit 2500 normalizes the gradient histogram calculated for the region using the gradient histogram calculated at step S3007 and the parameters set at step S3005.

At step S3009, the gradient-histogram feature vector generating unit 2500 generates feature vectors from the normalized gradient histogram for each region generated at step S3008. Thereafter, the expression identifying unit 2600 inputs the generated feature vectors to individual expression code classifiers for identifying expression codes and detects whether motions of facial-expression muscles corresponding to respective expression codes are occurring.

At step S3010, the expression identifying unit 2600 identifies an expression based on the combination of occurring expression codes. Then, at step S3011, the face image normalizing unit 2200 determines whether expression identification has been performed on all faces detected at step S3001. If it is determined that expression identification has not been performed on all faces, the flow returns to step S3003.

On the other hand, if it is determined at step S3011 that expression identification has been performed on all faces, the flow proceeds to step S3012. At step S3012, it is determined whether processing on the next image should be executed. If it is determined that processing on the next image should be executed, the flow returns to step S3000. However, if it is determined at step S3012 that processing on the next image is not performed, the entire process is terminated.

As described, the present embodiment defines multiple regions in a normalized image and uses gradient histogram parameters according to the regions. Thus, more precise expression identification can be realized.

### Third Embodiment

The third embodiment of the invention will be described. The third embodiment illustrates identification of an individual using multi-resolution images.

FIG. 1C is a block diagram illustrating an exemplary functional configuration of an image recognition apparatus 3001 according to the third embodiment.

In FIG. 1C, the image recognition apparatus 3001 includes an image input unit 3000, a face detecting unit 3100, a image normalizing unit 3200, a multi-resolution image generating unit 3300, a parameter setting unit 3400, a gradient-histogram feature vector generating unit 3500, and an individual identifying unit 3600.

As the image input unit 3000, the face detecting unit 3100 and the image normalizing unit 3200 are similar to the image input unit 1000, the face detecting unit 1100 and the image normalizing unit 1200 of FIG. 1A described in the first embodiment, their descriptions are omitted. Also, the distance between eye centers Ew used by the image normalizing unit 3200 is 30 as in the second embodiment.

The multi-resolution image generating unit 3300 further applies thinning or the like to an image normalized by the image normalizing unit 3200 (a high-resolution image) to generate an image of a different resolution (a low-resolution image). In the present embodiment, the width and height of a high-resolution image generated by the image normalizing unit 3200 are both 60, and the width and height of a low-resolution image are both 30. The width and height of images are not limited to these values.

The parameter setting unit 3400 sets gradient histogram parameters according to resolution using a table as illustrated in FIG. 6B.

The gradient-histogram feature vector generating unit 3500 generates feature vectors for each resolution using parameters set by the parameter setting unit 3400. For generation of feature vectors, a similar process to that of the first embodiment is carried out. For a low-resolution image, gradient histograms generated from the entire low-resolution image are used to generate a feature vector V_{L}.

Meanwhile, for a high-resolution image, regions are defined as in the second embodiment and gradient histograms generated from the regions are used to generate feature vectors V_{H} as illustrated in FIG. 4. Thus, feature vector V_{L} generated from a low-resolution image indicate global and rough features while feature vectors V_{H} generated from regions of a high-resolution image indicate local and fine features for facilitating identification of an individual.

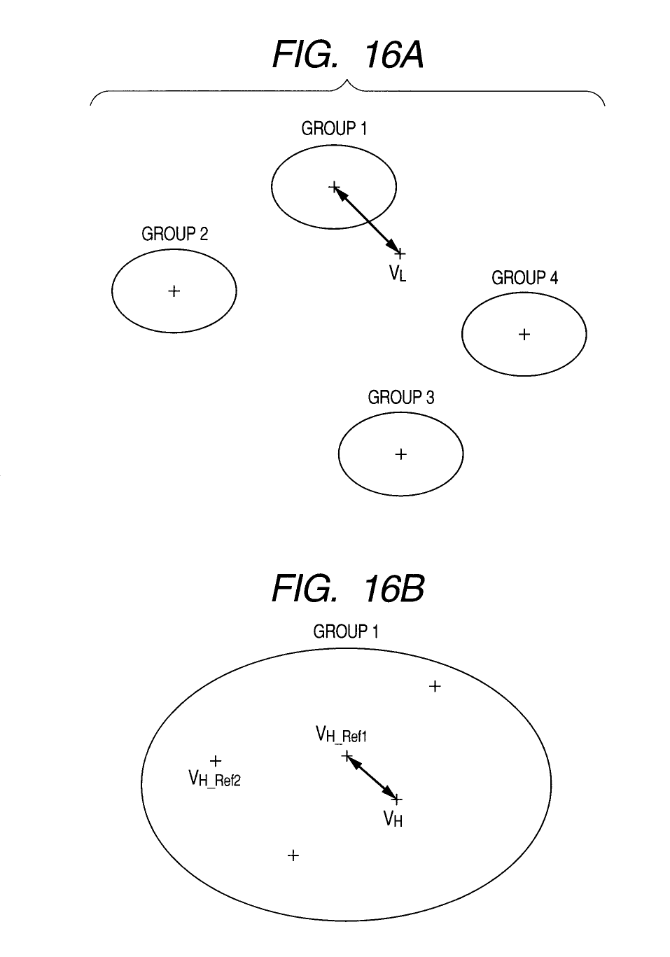

The individual identifying unit 3600 first determines to which group a feature vector V_{L} generated from a low-resolution image is closest, as illustrated in FIG. 16A. Specifically, pre-registered feature vectors for individuals are clustered in advance using k-mean method described in S. Z. Selim and M. A. Ismail, “K-means-Type Algorithm”, IEEE Trans. On Pattern Analysis and Machine Intelligence, 6-1, pp. 81-87, 1984, or the like. Then, based on comparison of the distance between the center position of each group and the feature vector V_{L} that has been input, a group to which the feature vector V_{L} is closest is identified. The example of FIG. 16A shows that the feature vector V_{L} is closest to group 1.

Then, the distance between a feature vector V_{H} generated from each of regions on the high-resolution image and a registered feature vector V_{H}_{_{—}}_{Ref} for an individual that is included in the group closest to the feature vector V_{L} is compared with other such distances. A registered feature vector V_{H}_{_{—}}_{Ref} closest to the input feature vector V_{H} is thereby calculated to finally identify an individual. The example illustrated in FIG. 16B indicates that the feature vector V_{H} is closest to registered feature vector V_{H}_{_{—}}_{Ref1} included in group 1.

Thus, the individual identifying unit 3600 first finds an approximate group using global and rough features extracted from a low-resolution image and then uses local and fine features extracted from a high-resolution image to distinguish individuals' fine features to identify an individual. To this end, the parameter setting unit 3400 defines a smaller region (a cell) from which to generate a gradient histogram and a narrower bin width (Δθ) of gradient histograms for a high-resolution image than for a low-resolution image as illustrated in FIG. 6B, thereby representing finer features.

### Fourth Embodiment

The fourth embodiment of the invention is described below. The fourth embodiment illustrates weighting of facial regions.

FIG. 1D is a block diagram illustrating an exemplary functional configuration of an image recognition apparatus 4001 according to the present embodiment.

In FIG. 1D, the image recognition apparatus 4001 includes an image input unit 4000, a face detecting unit 4100, a face image normalizing unit 4200, a region setting unit 4300, and a region weight setting unit 4400. The image recognition apparatus 4001 further includes a region parameter setting unit 4500, a gradient-histogram feature vector generating unit 4600, a gradient-histogram feature vector consolidating unit 4700, and an expression identifying unit 4800.

As the image input unit 4000, the face detecting unit 4100 and the face image normalizing unit 4200 are similar to the image input unit 2000, the face detecting unit 2100, and the face image normalizing unit 2200 of the second embodiment, their descriptions are omitted. Also, the distance between eye centers Ew used in the face image normalizing unit 4200 is 30 as in the second embodiment. The region setting unit 4300 defines eye, cheek, and mouth regions through a similar procedure as that of the second embodiment as illustrated in FIG. 4.

The region weight setting unit 4400 uses the table shown in FIG. 6C to weight regions set by the region setting unit 4300 based on the distance between eye centers Ew. A reason for weighting regions set by the region setting unit 4300 according to the distance between eye centers Ew is that a change in a cheek region is very difficult to capture when face size is small and thus only eyes and mouth are used for expression recognition when face size is small.

The region parameter setting unit 4500 sets parameters for individual regions for generation of gradient histograms by the gradient-histogram feature vector generating unit 4600 using such a table as illustrated in FIG. 6A as in the second embodiment.

The gradient-histogram feature vector generating unit 4600 generates feature vectors using parameters set by the region parameter setting unit 4500 for each of regions set by the region setting unit 4300 as in the first embodiment. The present embodiment denotes a feature vector generated from an eye region 320 shown in FIG. 4 as Vₑ, a feature vector generated from the right-cheek and left-cheek regions 321 and 322 as V_{c}, and a feature vector generated from the mouth region 313 as Vₘ.

The gradient-histogram feature vector consolidating unit 4700 generates one feature vector according to Equation (6) using three feature vectors generated by the gradient-histogram feature vector generating unit 4600 and a weight set by the region weight setting unit 4400:

V=ωₑVₑ+ω_{c}V_{c}+ωₘVₘ (6)

The expression identifying unit 4800 identifies a facial expression using SVMs as in the first embodiment with the weighted feature vector generated by gradient-histogram feature vector consolidating unit 4700.

As described above, according to the present embodiment, more precise expression identification can be realized because regions from which to generate feature vectors are weighted based on the distance between eye centers Ew.

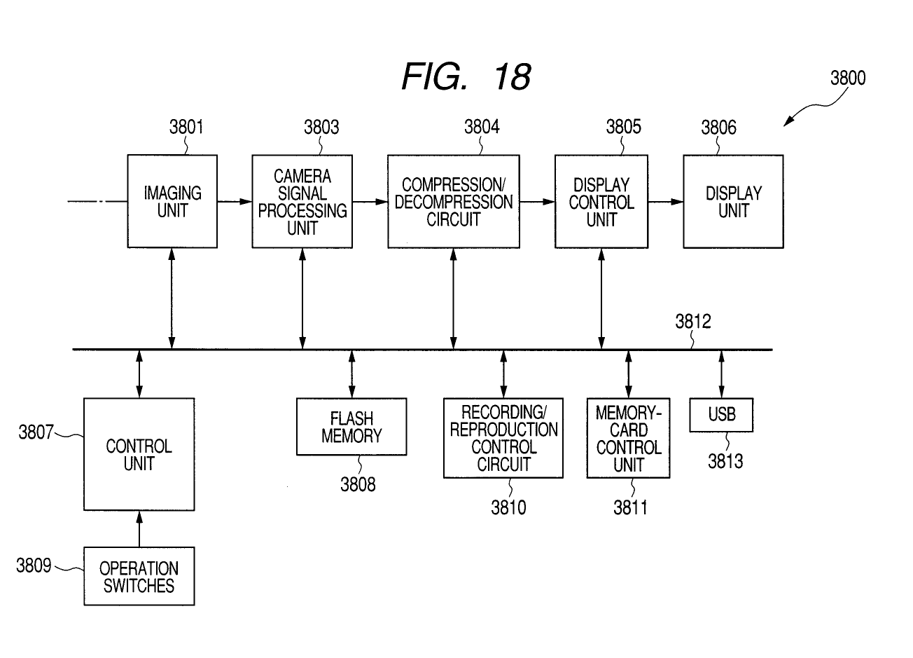

The techniques described in the first to fourth embodiments are applicable not only to image search but imaging apparatus such as digital cameras, of course. FIG. 18 is a block diagram illustrating an exemplary configuration of an imaging apparatus 3800 to which the techniques described in the first to fourth embodiments are applied.

In FIG. 18, an imaging unit 3801 includes lenses, a lens driving circuit, and an imaging element. Through driving of lenses, such as an aperture, by the lens driving circuit, an image of a subject is formed on an image-forming surface of the imaging element, which is formed of CCDs. Then, the imaging element converts light to electric charges to generate an analog signal, which is output to a camera signal processing unit 3803.

The camera signal processing unit 3803 converts the analog signal output from the imaging unit 3801 to a digital signal through an A/D converter not shown and further subjects the signal to signal processing such as gamma correction and white balance correction. In the present embodiment, the camera signal processing unit 3803 performs the face detection and image recognition described in the first to fourth embodiments.

A compression/decompression circuit 3804 compresses and encodes image data which has been signal-processed at the camera signal processing unit 3803 according to a format, e.g., JPEG. And the target image data is recorded in flash memory 3808 with control by a recording/reproduction control circuit 3810. Image data may also be recorded in a memory card or the like attached to a memory-card control unit 3811, instead of the flash memory 3808.

When any of operation switches 3809 is manipulated and an instruction for displaying an image on a display unit 3806 is given, the recording/reproduction control circuit 3810 reads image data recorded in the flash memory 3808 according to instructions from a control unit 3807. Then, the compression/decompression circuit 3804 decodes the image data and outputs the data to a display control unit 3805. The display control unit 3805 outputs the image data to the display unit 3806 for display thereon.

The control unit 3807 controls the entire imaging apparatus 3800 via a bus 3812. A USB terminal 3813 is provided for connection with an external device, such as a personal computer (PC) and a printer.

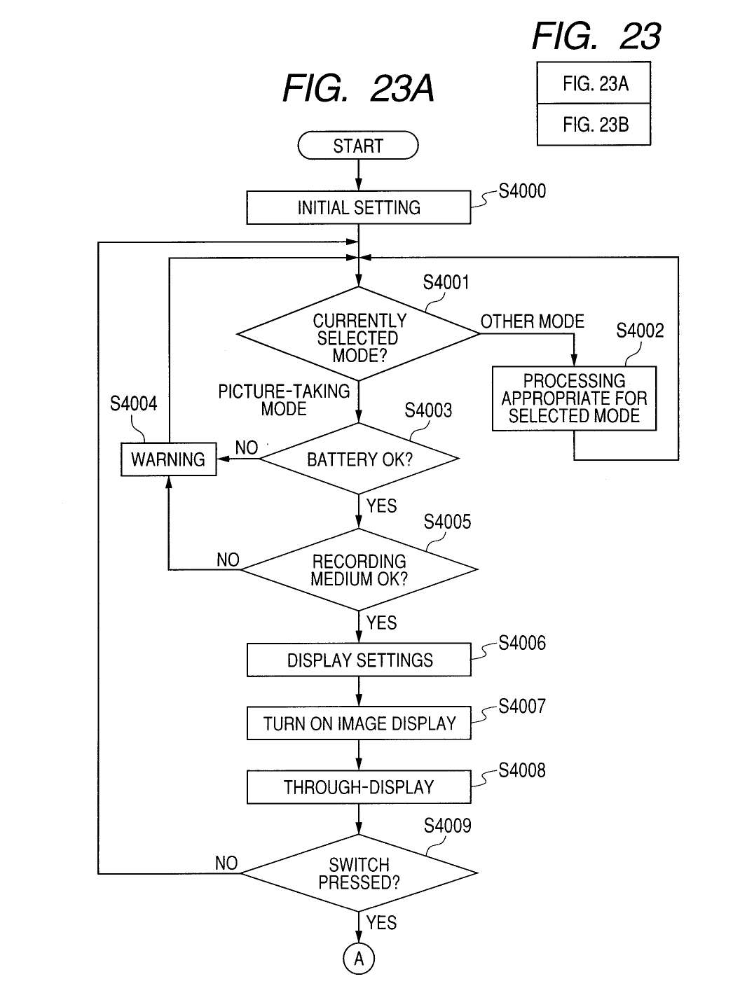

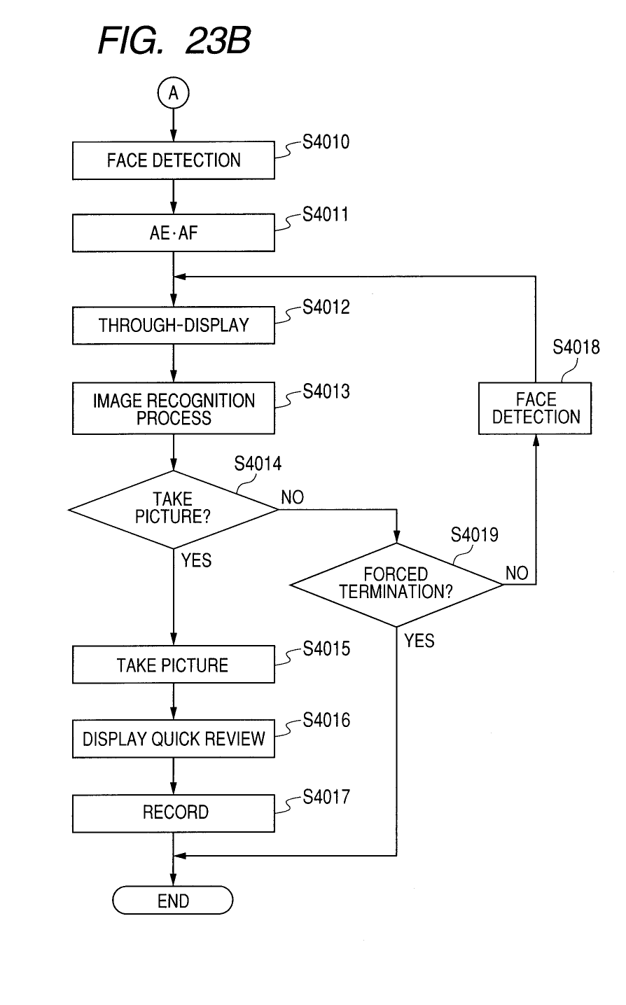

FIGS. 23A and 23B are flowcharts illustrating an example of processing procedure that can be performed when the techniques described in the first to fourth embodiments are applied to the imaging apparatus 3800. The steps shown in FIGS. 23A and 23B are carried out with control by the control unit 3807.

In FIGS. 23A and 23B, processing is started upon the imaging apparatus being powered up. First, at step S4000, various flags and control variables within internal memory of the imaging apparatus 3800 are initialized.

At step S4001, current setting of an imaging mode is detected, and it is determined whether the operation switches 3809 have been manipulated by a user to select an expression identification mode. If it is determined that a mode other than expression identification mode has been selected, the flow proceeds to step S4002, where processing appropriate for the selected mode is performed.

If it is determined at step S4001 that expression identification mode is selected, the flow proceeds to step S4003, where it is determined whether there is any problem with the remaining capacity or operational condition of a power source. If it is determined that there is any problem, the flow proceeds to step S4004, where the display control unit 3805 provides a certain warning with an image on the display unit 3806 and the flow returns to step S4001. The warning may be sound instead of an image.

On the other hand, if it is determined at step S4003 that there is no problem with the power source or the like, the flow proceeds to step S4005. At step S4005, the recording/reproduction control circuit 3810 determines whether there is any problem with image data recording/reproduction operations to/from the flash memory 3808. If it is determined there is any problem, the flow proceeds to step S4004 to give a warning with an image or sound and returns to step S4001.

If it is determined at step S4005 that there is no problem, the flow proceeds to step S4006. At step S4006, the display control unit 3805 displays a user interface (hereinafter, UI) for various settings on the display unit 3806. Via the UI, the user makes various settings.

At step S4007, according to the user's manipulation of the operation switches 3809, image display on the display unit 3806 is set to ON. At step S4008, according to the user's manipulation of the operation switches 3809, image display on the display unit 3806 is set to through-display state for successively displaying image data as taken. In the through-display state, data sequentially written to internal memory is successively displayed on the display unit 3806 so as to realize electronic finder functions.

Then, at step S4009, it is determined whether a shutter switch for indicating start of picture-taking mode included in the operation switches 3809 has been pressed by the user. If it is determined that the shutter switch has not been pressed, the flow returns to step S4001. However, if it is determined at step S4009 that the shutter switch has been pressed, the flow proceeds to step S4010, where the camera signal processing unit 3803 carries out face detection as described in the first embodiment.

If a person's face is detected at step S4010, AE and AF controls are effected on the face at step S4011. Then, at step S4012, the display control unit 3805 displays the captured image on the display unit 3806 as a through-image.

At step S4013, the camera signal processing unit 3803 performs image recognition as described in the first to fourth embodiments. At step S4014, it is determined whether the result of the image recognition performed at step S4013 is in a predetermined state, e.g., whether the face detected at step S4010 shows an expression of joy. If it is determined that the result indicates a predetermined state, the flow proceeds to step S4015, where the imaging unit 3801 performs actual image taking and records the taken image. For example, if the face detected at step S4010 exhibits an expression of joy, actual image taking is carried out.

Then, at step S4016, the display control unit 3805 displays the taken image on the display unit 3806 as a quick review. At step S4017, the compression/decompression circuit 3804 encodes the taken image of a high-resolution, and the recording/reproduction control circuit 3810 records the image in the flash memory 3808. That is to say, a low-resolution image compressed through thinning or the like is used for face detection, and a high-resolution image is used for recording.

On the other hand, if it is determined at step S4014 that the result of image recognition is not in a predetermined state, the flow proceeds to S4019, where it is determined whether forced termination is selected by the user's operation. If it is determined that forced termination has been selected by the user, processing is terminated here. However, if it is determined at step S4019 that forced termination is not selected by the user, the flow proceeds to step S4018, where the camera signal processing unit 3803 executes face detection on the next frame image.

As has been described, according to the present embodiment as applied to an imaging apparatus, more precise expression identification can be realized also for a captured image.

Various exemplary embodiments, features, and aspects of the present invention will now be herein described in detail below with reference to the drawings. It is to be noted that the relative arrangement of the components, the numerical expressions, and numerical values set forth in these embodiments are not intended to limit the scope of the present invention.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to the embodiments, it is to be understood that the invention is not limited to the disclosed embodiments. The scope of the following claims is to be accorded the broadest interpretation so as to encompass all such modifications and equivalent structures and functions.

This application claims the benefit of Japanese Patent Application No. 2009-122414, filed on May 20, 2009, which is hereby incorporated by reference herein in its entirety.

What is claimed is:

1. An image recognition apparatus comprising:
a detecting unit constructed to detect a person's face from input image data;
a parameter setting unit constructed to set parameters for generating a gradient histogram indicating gradient direction and gradient magnitude of a pixel value based on the face detected by the detecting unit;
a region setting unit constructed to set, in the region of the detected face, at least one region from which the gradient histogram is to be generated, based on the parameters set by the parameter setting unit;
a generating unit constructed to generate the gradient histogram for each of the regions set by the region setting unit, based on the parameters set by the parameter setting unit; and
an identifying unit constructed to identify the detected face using the gradient histogram generated by the generating unit.

2. The image recognition apparatus according to claim 1, further comprising a calculating unit constructed to calculate the gradient direction and gradient magnitude for the region of the detected face based on the parameters set by the parameter setting unit,
wherein the generating unit generates the gradient histogram using the calculated gradient direction and gradient magnitude.

3. The image recognition apparatus according to claim 1, further comprising a first normalizing unit constructed to normalize the region of the detected face so that the detected face has a predetermined size and a predetermined orientation,
wherein the region setting unit sets, in the normalized region of the face, at least one region from which the gradient histogram is to be generated.

4. The image recognition apparatus according to claim 1, further comprising a second normalizing unit constructed to normalize the gradient histogram generated by the generating unit for each of the regions set by the region setting unit,
wherein the identifying unit identifies the detected face using the normalized gradient histogram.

5. The image recognition apparatus according to claim 1, further comprising:
an extracting unit constructed to extract a plurality of regions from the region of the detected face; and
a weighting unit constructed to weight the gradient histogram for each of the regions extracted by the extracting unit.

6. The image recognition apparatus according to claim 1, further comprising an image generating unit constructed to generate images of different resolutions from the region of the detected face,
wherein the identifying unit identifies the detected face using gradient histograms generated from the generated images of different resolutions.

7. The image recognition apparatus according to claim 1, wherein the parameters set by the parameter setting unit are an area for calculating the gradient direction and the gradient magnitude, a size of a region to be set by the region setting unit, a width of bins in the gradient histogram, and a number of gradient histograms to be generated by the generating unit.

8. The image recognition apparatus according to claim 2, wherein the calculating unit calculates the gradient direction and the gradient magnitude by making reference to values of top, bottom, left, and right pixels positioned at a predetermined distance from a predetermined pixel.

9. The image recognition apparatus according to claim 1, wherein the gradient histogram is a histogram whose horizontal axis represents the gradient direction and vertical axis represents the gradient magnitude.

10. The image recognition apparatus according to claim 1, wherein the identifying unit identifies a person's facial expression or an individual.

11. An imaging apparatus comprising:
an imaging unit constructed to capture an image of a subject and generate image data;
a detecting unit constructed to detect a person's face from the image data generated by the imaging unit;
a parameter setting unit constructed to set parameters for generating a gradient histogram indicating gradient direction and gradient magnitude of a pixel value based on the face detected by the detecting unit;
a region setting unit constructed to set, in the region of the detected face, at least one region from which the gradient histogram is to be generated, based on the parameters set by the parameter setting unit;
a generating unit constructed to generate the gradient histogram for each of the regions set by the region setting unit, based on the parameters set by the parameter setting unit;
an identifying unit constructed to identify the detected face using the gradient histogram generated by the generating unit; and
an image recording unit constructed to record the image data if the identification made by the identifying unit shows a predetermined result.

12. An image recognition method comprising:
detecting a person's face from input image data;
setting parameters for generating a gradient histogram indicating gradient direction and gradient magnitude of a pixel value, based on the detected face;
setting, in the region of the detected face, at least one region from which the gradient histogram is to be generated, based on the set parameters;
generating the gradient histogram for each of the set regions, based on the set parameters; and
identifying the detected face using the generated gradient histogram.

13. An imaging method comprising:
capturing an image of a subject to generate image data;
detecting a person's face from the generated image data;
setting parameters for generating a gradient histogram indicating gradient direction and gradient magnitude of a pixel value, based on the detected face;
setting, in the region of the detected face, at least one region from which the gradient histogram is to be generated, based on the set parameters;
generating the gradient histogram for each of the set regions, based on the set parameters;
identifying the detected face using the generated gradient histogram; and
recording the image data if the identification shows a predetermined result.

14. A computer-readable storage medium that stores a computer program for causing a computer to execute the method according to claim 12.

15. A computer-readable storage medium that stores a computer program for causing a computer to execute the method according to claim 13.
